(19) United States
(12) Patent Application Publication
(10) Pub. No.: US 2019/0002179 A1
(43) Pub. Date: Jan. 3, 2019

(54) Nanostructured latex film for controlling and monitoring bacterial cell growth in food packaging

(71) Applicant: Åbo Akademi, Åbo (FI)

(72) Inventors: Sven Emil Alexander ROSQVIST, Turku (FI); Jouko Pertti Kalervo PELTONEN, TURKU (FI); John Elias ERIKSSON, Turku (FI); Erik Johan Niemelä, Turku (FI)

(21) Appl. No.: 16/033,265

(22) Filed: Jul. 12, 2018

Related U.S. Application Data
(63) Continuation-in-part of application No. 15/755,136, filed on Feb. 26, 2018.

(30) Foreign Application Priority Data
Aug. 26, 2015 (FI) 20155608
Nov. 13, 2015 (FI) 20155840

(51) Int. Cl. B65D 81/28; G01N 27/327; G01N 35/00; B32B 27/30; B32B 15/082; B32B 7/04

(52) U.S. Cl. CPC B65D 81/28; G01N 27/3278; G01N 35/00871; B32B 27/302; B32B 15/082; B32B 7/045; G01N 2035/00881; B32B 2307/412; B32B 2307/202; B32B 2307/732; B32B 2307/7145; B32B 2439/70; B65D 2203/10

(57) ABSTRACT

This invention describes the production of a polymeric film, specifically a mix of two different lattices, in order to obtain a barrier layer in food packaging that reduces bacterial cell growth. Said reduction in bacterial growth is a result of choosing not only a surface with chemical properties to prevent bacterial growth, but also, and especially, controlling the nanostructure of the surface in order to prevent bacterial adhesion and so prevent bacterial film formation. This is done by using a mixture of two lattices and thermally annealing the surface as needed to such surface topography that bacterial growth is decreased. This invention addresses the need for an increased shelf-life of groceries in order to reduce spoilage losses, and thus waste. In addition, this invention supports the need to monitor the spoilage of packaged food so that less food is unnecessarily disposed of and on the other hand, so that spoiled food is not consumed by humans. This is achieved by both adding a sensing electrode on the latex surface for monitoring cellular processes and by adding and radio-frequency identification device for sending and receiving information regarding the status of the food product.

### PRIORITY

This application is a continuation-in-part of and claims priority to co-owned and co-pending U.S. patent application Ser. No. 15/755136, filed Feb. 26, 2018 and titled “A transparent or semi-transparent nanostructured latex film for flexible and semi-transparent electronics for monitoring and manipulating cellular processes”, which is incorporated herein by reference in its entirety.

### FIELD OF THE INVENTION

This invention pertains to the field of food packaging and to the field of nanostructured films for controlling and monitoring cellular processes. More specifically this invention pertains to intelligent and active food packaging, that can be functionalized with semi-transparent electronics for monitoring and manipulating cellular processes, wherein said nanostructured film controls cellular attachment and growth.

### BACKGROUND ART

Current solutions for reducing bacterial growth in food packaging often involve adding chemicals, silver ions, antibiotics, benzoic acid, nanoparticles or other antibacterial compounds to the packing material in order to achieve prolonged shelf-life [1]. These compounds can however be toxic to the environment and for human consumption, especially when accumulated in larger quantities [2]. To be able to create inert materials that reduce bacterial growth without toxic compounds would open up a new dimension of food packing technologies. Therefore, controlling cell growth by influencing the surface topography of non-toxic materials such as latices it would be possible to create inertly antimicrobial surfaces that could prolong the shelf-life of food products [3]. As it is, latices are widely used to manufacture millions of consumer and commercial products and due to the ease-of-processing of latex it would be a suitable material to be used in both active and intelligent packing technologies [4].

The influence of surface topography and in vivo mimicking of 3D features in cell cultures has been studied [5, 6, 7, 8, 9]. Nano- and micro-textured surfaces have been fabricated by several methods, often by photolithography and etching [8, 10, 11]. Biodegradable thin films of poly-L-lactic acid [12] and chitosan [13] have been fabricated using soft lithographic techniques by applying the polymer solutions on the template surfaces and by peeling them off after solvent evaporation. Zhang et al. has used focused ion beam milling to create regularly patterned gold films with a wide palette of colors without employing any form of chemical modification [14]. Morariu et al. has described an electric field-induced sub-100-nm scale structure formation process using polymer bilayers [15].

Similarly, surface topography has been shown to critically influence bacterial cell attachment in several studies. In the case of S. sanguinis on differently manufactured PMMA surfaces [16]; the adhesion of S. aureus and P. aeruginosa onto ultrafine-grained titanium [17]; the adhesion of S. aureus, S. epidermis, P. aeruginosa and E. coli (as well as human osteoblasts) on shot peened 316L stainless steel [18]. The use of nanostructured surfaces has been suggested e.g. in medical applications, such as medical sutures to obtain antibacterial properties and thereby prevent infection of e.g. the sutured wound [19].

A biocompatible and nanostructured latex blend has been proven to be a non-toxic substrate material for both eukaryotic and prokaryotic cells [20] [21]. By fine-tuning the surface topography of the latex it is possible to create a surface that is either cell-repellent or cell-supporting [20]. Furthermore, functionalized nanostructured latex has been shown to be antimicrobial to the bacterium Staphylococcus aureus that could be used in development of active surfaces in order to reduce the risk of food-borne intoxications [21]

Radio frequency identification (RFID) technology provides a means to activate passive tags or sensors for measurement and readout. Such passive sensors can be made very simple and produced very cost-effectively, as they do not require a power source [22]. In RFID sensing the resonance impedance spectrum of the antenna can detect chemical, biological or physical properties or changes in the surrounding environment, i.e. the food package [23]. Classically, RFID tags applied in the food industry have been associated with temperature readouts and food safety, where the readout could be the presence pathogens, or the gaseous chemicals formed during ripening or fouling of the packed food, for instance milk or fish. [22, 23] A more advanced intelligent package could include a gas sensor for detecting sulfur compounds from rotting meat [24] or an ethylene sensor for detecting ripening of apples [25]. [26] Furthermore, by adding an impedance-measuring electrode it would be possible to obtain detailed information on cellular processes such as cell adhesion, growth, pH, metabolites and glucose content [27, 28, 29, 30].

### SUMMARY OF INVENTION

It is an aim of the present invention to control and monitor bacterial cells present in commercial products, such as food packaging and pharmaceutical packing, and medical devices in order to prolong shelf-life and decrease the risk of bacterial infection.

It is another aim of the present invention to provide nanostructured transparent or semi-transparent latex films for flexible and semi-transparent electronics, wherein said film can be self-supporting or said film is on a support material.

It is a third aim of the present invention to provide an electronics assembly for monitoring and manipulating cellular processes in real-time.

It is a fourth aim of the present invention to provide the electronic assembly capabilities of sending and receiving information regarding the content of a food product in a package.

The present invention is further directed to a functionalized transparent or semi-transparent nanostructured latex film on a transparent support such as plastic or glass or on a non-transparent support such as paper and cardboard.

Especially, the present invention provides a nanostructured polymeric latex coating that increases shelf-life equipped with a sensing electrode with an additional radio-frequency identification (RFID) sensor, or similar.

More specifically, the present invention is characterized by what is stated in the characterizing parts of the independent claims.

Considerable advantages are obtainable with the present invention. Thus, substrates with specific properties can control cell-substrate interactions and induce cellular processes and decisions by means of passive and/or active control to either enhance or decrease bacterial cell proliferation and adhesion.

By means of the present invention it is possible accurately to control the nanostructure (FIG. 1) and surface chemistry of the latex film as defined herein. To be able to design surfaces that support, regulate, and monitor biological processes is an approach, which has immense potential in different applications in applied research and consumer markets.

There is an immeasurable need within food industry, medical industry, construction material industry and consumer market for inexpensive biocompatible materials that can be easily produced and customized for controlling and monitoring specific cell types. In many cases, the possibility to sense and follow biological responses taking place within the employed materials would improve the shelf-life of food products by controlling the complicated cellular interactions with the enclosed environment. The present invention enables production of man-made materials with both active and intelligent food package capabilities in order to meet such needs.

By including a sensing electrode on the latex film, it is possible, for example, to detect and measure the metabolites of cells or manipulate cellular processes in real-time. The present invention presents a novel hybrid active and intelligent food packing; Its active part is composed of a transparent and both chemically and topographically customized latex film, and the intelligent part is composed of sensing electrodes that enable real-time measurement of e.g. pH and ion concentration within the food packing environment as well as the metabolic states of the cells.

Next, embodiments will be described in more detail.

### BRIEF DESCRIPTION OF THE DRAWINGS

FIG. 1. a) AFM topographical image (5 μm×5 μm) b) 3D reconstruction and c) line profile of a nanostructured latex surface from a 50:50 PS:ABS blend sintered for 30 seconds 1 hour after coating.

FIG. 2. a) A photograph and b) transmittance spectrum covering the visible wavelength area show the good transparency of the latex film and the evaporated gold electrodes. The numbers on the computer screen in the background are clearly visible even through the gold film. A comparison of the topography prior to gold evaporation (c, d) and after gold evaporation on latex film (e, f) is seen in the AFM (5 μm×5 μm) images and the corresponding line profiles. The gold deposition is apparent through the fine structure as small grains of about 6 nm in height on top of the latex surface.

FIG. 3 a) The long-term stability of the electrode on the latex surface in cell media has been confirmed during impedance spectrometry. This is seen as a negligible change after the KCl electrolyte (black squares) is replaced by cell media (colored boxes). A much bigger change is expected when the electrodes are covered by cells. b) The capacitive response changes as HDF cells attach to the surface of a gold electrode on a nanostructured latex film after being seeded (0h). The capacitance decreased as more cells attach to the surface. After ca 3 hours the majority of cells have attached and are spreading, which again increased the capacitance.

FIG. 4. A schematic presentation of different fabrication steps for latex films which for example are suitable for use as active food packing material for controlling cell growth.

FIG. 5. Variation of cell growth visible on the nanostructured latex coated coverslips using Human Dermal Fibroblast (HDF). On the top, HDF cells grown on a non-coated glass cover slip, after 24 h (left) and 96 h (right). In the next rows, HDF cells grown on latex blends (HPY83:HPC26-50:50, 60:40, 40:60) coated on glass cover slip grown for 24 h (left) and 96 h (right). Variations in cell growth visible on the nanostructured latex coated coverslips compared to non-coated glass surface using HDF cells. The HPY83:HPC26-50:50 and 60:40 increases cell growth whereas the 40:60 blend decreases cell growth. Variations

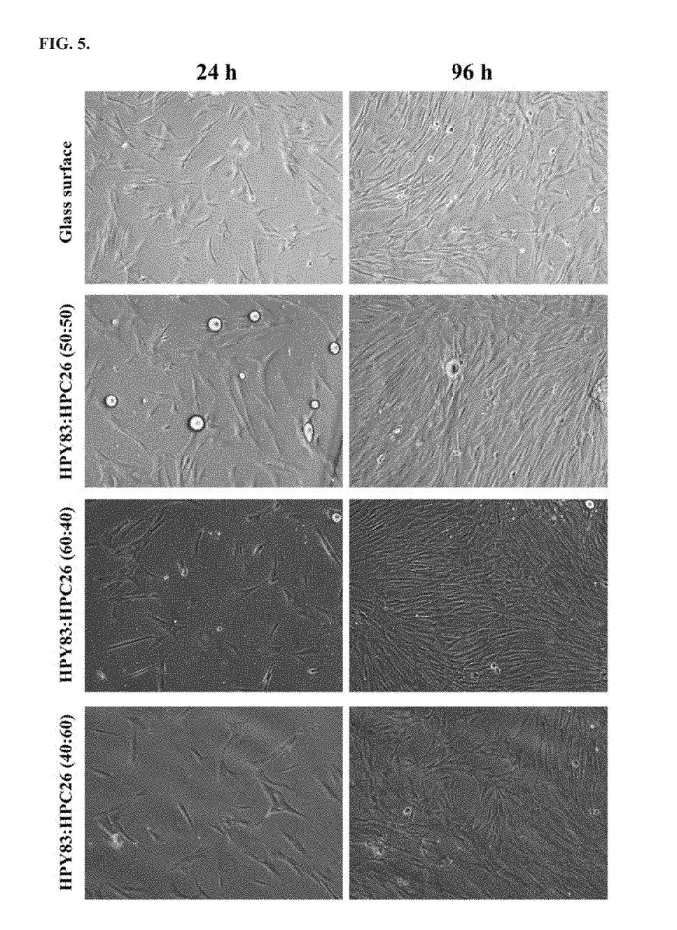

FIG. 6. Quantified HDF cell growth with a latex blend at different PS to ABS ratios, shown as cell growth relative to that observed on glass (normalized as 1.00). The nanostructured latex films dramatically affects cell growth compared to glass, for example, the 50:50 and 60:40 blend increases significantly cell growth whereas the 40:60 decreases growth. These variations have been correlated to changes in roughness of the surface film.

FIG. 7. Key roughness parameters that affect the proliferation of HDF cells on the latex surfaces with tuned roughness have been observed to be, among others, Sdr (effective surface area) and Sq/Scl (the RMS-roughness normalised with the correlation length, the lateral roughness).

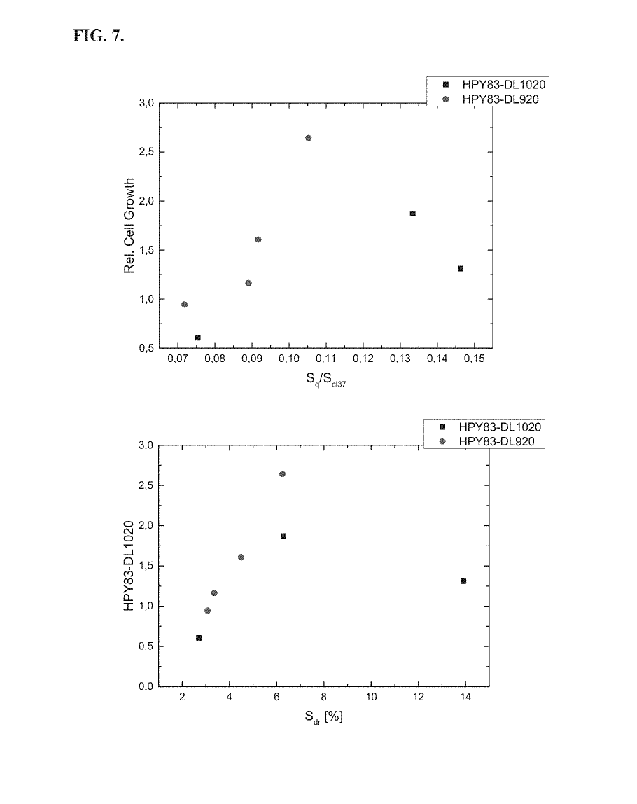

FIG. 8 is a schematic illustration of hierarchically structured latex based electronics with built in radio-frequency identification device for monitoring and manipulating cellular processes in food packing. The exemplary milk carton depicted in FIG. 8 incorporates active and intelligent packing in accordance with at least some embodiments of the invention. In the context of at least FIG. 8, active packing refers to nanostructured surface coating for controlling cell growth, comprising tailored surface chemistry for controlling cellular processes such cell adhesion, growth, morphology and apoptosis. With respect to food quality the mobile device in the figure displays a visual element indicating the food quality is acceptable, or an electronic device can be used for read-out. Regarding intelligent packaging, in the context of FIG. 8 that relates to a sensing electrode with built-in radio frequency identification (RFID). More specifically, the sensing electrode has a built in RFID device for sending and receiving information regarding e.g. metabolites, pH, sulphur compounds and glucose content. With respect to the product surface, it may incorporate the nanostructured coating and be functionalized with additional anti-microbial coating (the coating is on the product surface, e.g. paper, cardboard, plastic, etc.) Alternatively or additionally, the product surface may be functionalized with an electrode and RFID in addition to the nanostructured coating.

### DESCRIPTION OF EMBODIMENTS

Cell signaling governs the fate of all cells. In the present invention, materials with specific surface properties, especially surface chemistry and roughness, have been developed and an understanding gained how cell-substrate interactions control cellular processes and decisions by means of passive and active control to for example enhance or decrease cell growth and cell adhesion.

This invention describes the production of a polymeric film, specifically a mix of two different polymers, in order to obtain a barrier layer in food packaging that reduces bacterial cell growth. Said reduction in bacterial growth is a result of choosing not only a surface with chemical properties to prevent bacterial adhesion and growth, but also, and especially, controlling the nanostructure of the surface in order to prevent bacterial adhesion and so prevent bacterial film formation. This is done by using a mixture of two lattices and thermally annealing the surface so that a surface topography that hinders bacterial adhesion is obtained, and therefore cell growth is decreased.

This invention addresses the need for an increased shelf-life of food products such as groceries in order to reduce spoilage losses, and thus consequently decrease waste. In addition, this invention supports the need to monitor the spoilage of packaged food so that less food is unnecessarily disposed of and on the other hand, so that spoiled food would not be consumed and health risks would thus be reduced.

With this principle, functionalized substrates with properties that can control cell-substrate interactions, induce cellular processes and decisions by means of passive and active control to either enhance or decrease cell proliferation, cell adhesion and/or induce cell death are provided.

By including a sensing electrode on the substrate, it is possible, for example, to measure the metabolites of cells or follow the adhesion of cells or the pH of the product in real-time.

As a substrate suitable for food packing and compatible for flexible and semi-transparent electronics, the present invention provides a transparent or semi-transparent latex film, wherein said film is self-supporting or said film is on a transparent or non-transparent support.

Thus, typically, the substrate comprises a structure which is transparent or semi-transparent and extends preferably along a plane, such that it allows for transmission of light, in particular light in the visible range, through the structure, for example at an angle of 45°-135°, in particular 60°-120°, for example about 90°, against the plane along which the substrate extends.

The transparent support can preferably be made of glass or polymer material, such as a thermoplastic material. Preferably, the film is transparent or semi-transparent with the transmission of light in visible range being over 50%, more preferably in the range of 70%-90%.

The terms “transparent” and “semi-transparent” refer herein to the field of optics so that transparency is understood as the physical property of allowing visible light to pass through the material without being scattered.

The transmission through the material, as discussed herein, is for example measured at an angle of 45° to 135°, in particular 60° to 120°, for example about 90°, against the plane along which the substrate extends.

The term “roll-to-roll processing” refers herein to the process of creating polymeric films or electronic devices on a roll of paper, board, flexible plastic or metal foil. It can refer to any process of applying coatings or printing by starting with a roll of a flexible material and re-reeling after the process to create an output roll.

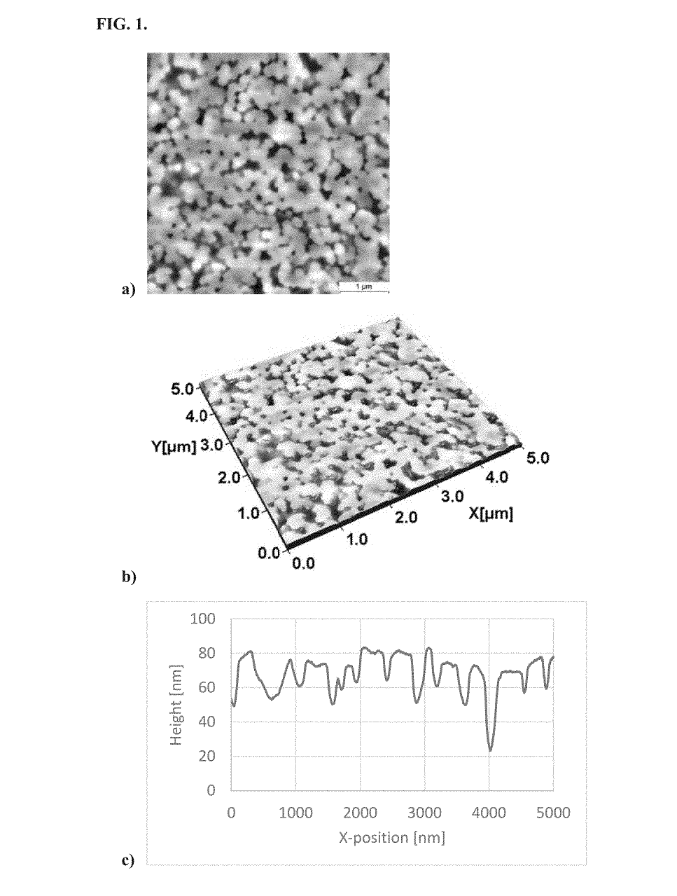

In one major embodiment of the invention, the latex film comprises a nanostructured surface having a hierarchical morphology. An example of the surface morphology is shown in FIG. 1. Latex blends used for preparing said films preferably comprise styrene and/or butadiene groups. Said nanostructured surface can be formed by a heat treatment, e.g. by sintering the latex film with an IR lamp.

Preferably, said latex film comprises a blend of two latexes (i.e. “hard” and “soft” latexes). More preferably, said two latexes comprise polymers selected from the group consisting of: styrene, acrylonitrile, butadiene (i.e. 1,3-butadiene) and copolymers thereof. Most preferably, said two latexes are polystyrene and styrene butadiene acrylonitrile copolymer. Said two latexes are mixed in a desired ratio to obtain the desired roughness. Preferable particle size for polystyrene is 100-200 nm providing barrier properties and integrity for the film.

The present technology thus provides a new food packaging platform composed of a transparent and chemically and topographically customized latex film, preferably with electrodes being processed on the film that enable real-time measurement of e.g. pH and ion concentration in the product as well as the metabolic states of the cells.

In a further embodiment, a non-transparent, semi-transparent or transparent electronics assembly is provided for monitoring and manipulating cellular processes in real-time. In particular the assembly comprises a hierarchically structured latex. Such an assembly is formed by
either a non-transparent, semi-transparent or transparent substrate with a deposited latex layer having a predetermined structure for active food packing; and
printed or evaporated electrodes for monitoring and manipulating cellular processes to be used for intelligent food packing.

Preferably, the electrodes allow for electrical monitoring for example in real-time.

Preferably, the electronics assembly gives detailed information on one or several of the following features: glucose content, pH, sulfur compounds, biogenic amines, cell adhesion, cell growth and cell morphology to be used in food packaging technologies and other corresponding consumer products.

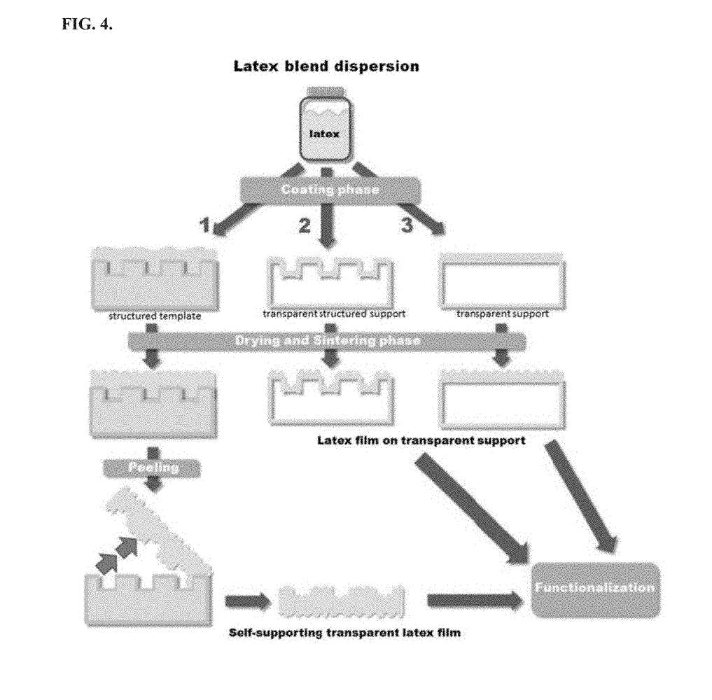

A schematic presentation of different fabrication steps for latex films is shown in FIG. 4. The latex comprises or consists of a synthetic or naturally occurring stable aqueous dispersion or emulsion of polymer particles, preferentially containing styrene and/or butadiene groups. The blend used is typically a mixture of two or more of aforementioned emulsions or dispersions.

The fabrication comprises four steps:
the coating phase,
the drying and sintering phase,
the peeling phase and
the functionalization phase.

The peeling phase is only necessary for the fabrication of self-supporting films, while the functionalization phase only applies if latex surfaces are desired to carry a surface functionalization. In the image three example lines are shown.

In the first line (1), latex is coated on the surface of a structured template, dried and sintered to obtain a desired surface, and finally peeled off to become a self-supporting latex film substrate.

In the second line (2), a latex coating is spread on a structured supporting substrate, and dried and sintered, to enable the design of a hierarchically structured surface.

Similarly, in the third line (3), latex is directly coated on a transparent supporting substrate without structure.

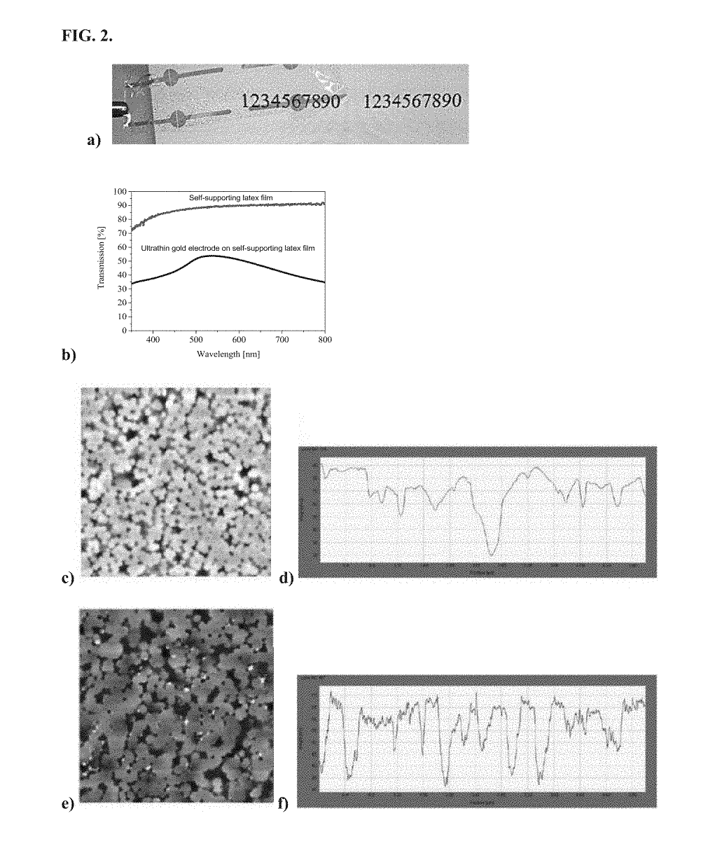

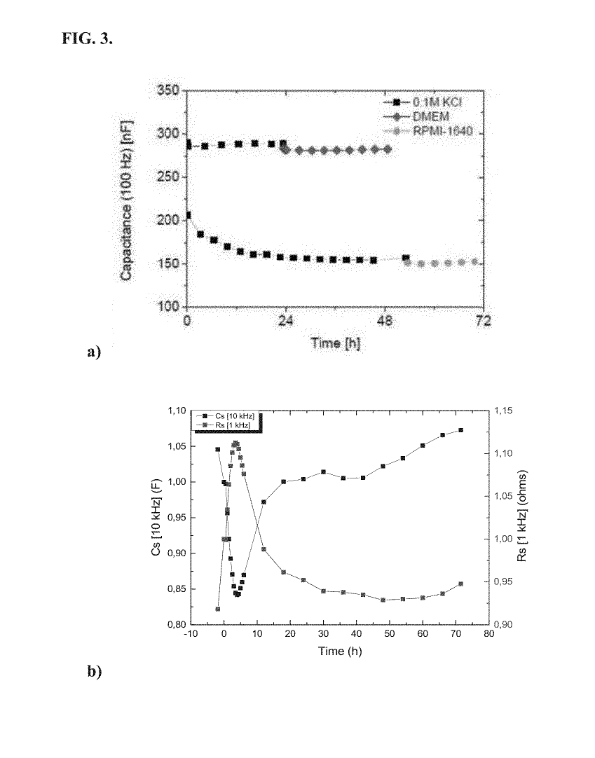

Different template materials can be used for creating various forms and structures for the latex substrates to be coated on, in particular so as to form boxes to be used in food packaging, milk carton or bottles to be used for liquids. Different latex blends and heat treatments give rise to different topography and surface chemistry. The highly transparent latex films can be self-supported as for example in FIG. 2a or then supported by for instance glass or paper (FIGS. 3b to 3c). A similar bimodal nanostructured surface topography is obtained for self-supported, paper- and glass supported substrates.

Electrically and electrochemically active semi-transparent layers for electric modulation and sensing can be deposited on the latex. For example, ultra-thin and conductive gold electrodes (UTGE) with 50% transmission can be evaporated or printed onto the latex surface (FIG. 2a). A preferred alternative is a semitransparent or transparent conductive polymer such as PEDOT:PSS.

UTGEs with nominal thickness of 20 nm were fabricated using physical vapor deposition with resistive heating and a shadow mask for patterning. The evaporation was done under high vacuum (10-6 mbar) using a heated aluminum-coated tungsten basket. A deposition monitor (XTM/2, Inficon) was used for gravimetric determination of the amount of evaporated gold on the film surface. With a nominal thickness of 20 nm, conductive UTGF electrodes (resistivity: 2.6×10-6 Ω cm) with grain thickness of about 6 nm were obtained.

The latex and electrode surfaces can be further or alternatively functionalized e.g. by antibiotics, metal ions, nanoparticles, printed biomolecule films or self-assembled thiol monolayers. Impedimetric studies confirmed a good long-term stability of the electrodes in high glucose content cell media, which is necessary for applications in the field of food packing for monitoring cellular processes where the time span of various products can be several days (FIG. 3b). Preferred biomolecules for functionalization also include active pharmaceutical ingredients (API) or other chemical compounds, such as toxic chemicals, having an effect on cell growth or activity.

The bare gold electrodes can also be used as such for measuring the concentration of electroactive analytes using cyclic voltammetry when an appropriate reference electrode is used. As an example, the intelligent packing platform can be used to determine the concentration of active medicinal components as demonstrated with caffeic acid in the Experimental Section below.

The electrodes can also be modified for instance by electro polymerizing a conductive polymer layer that allows a continuous monitoring of the pH or concentration of glucose or other cell metabolites in the cultivation area during cell growth. By using ion selective membranes on the electrode the concentration of different ions, e.g. potassium [K+], can be analyzed.

The transparency of both the latex substrate and the thin electrodes (FIG. 2a,b) enables transparent food packing solution to be produced combined with the electrical measurements which opens up direct correlation of variable parameters such as cellular metabolites, cell adhesion, cell growth and glucose levels. Specific advantages of electrical methods are the ability to detect low concentrations of biological analytes and the label-free analysis techniques.

One typical food package platform is based on a transparent material such as glass or plastic, modified with a latex-based structured surface topography, tailored surface chemistry and semi-transparent electrodes for both active and intelligent packing solutions. It gives, in real-time, detailed information on cellular processes such as cell adhesion, growth, morphology, pH, metabolites, sulfur compounds, biogenic amines and glucose content.

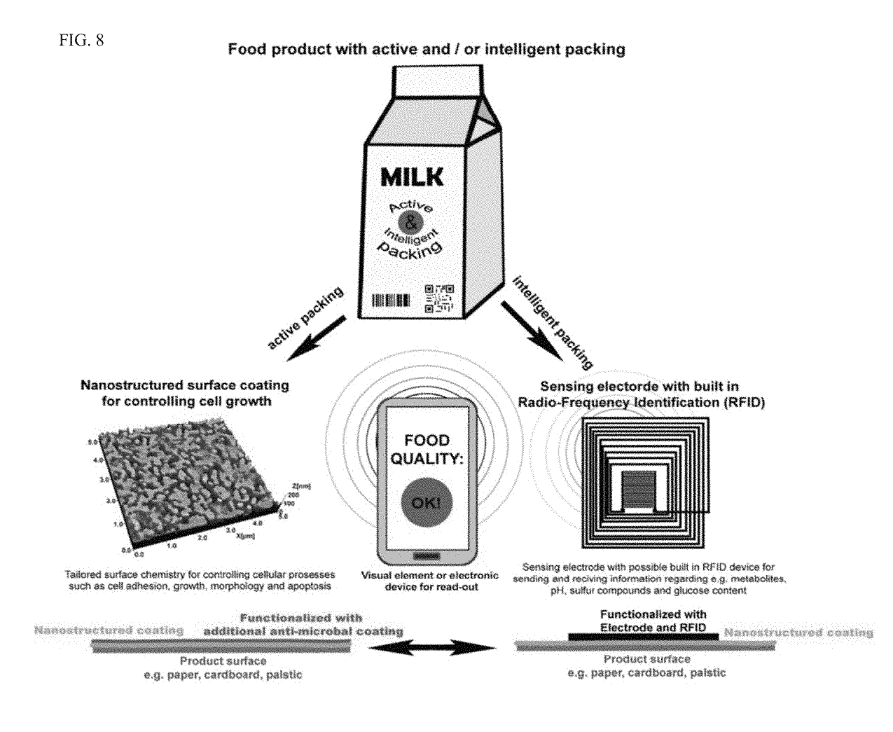

The materials can be designed to control cell growth or cellular adhesion in a desired manner. The electrodes open up the possibility to control cell fates by electrical stimulus, controlled chemical or drug release and to simultaneously measure pH and metabolites in the food product as well as glucose levels during the lifespan of the product giving detailed information regarding the product (FIG. 8).

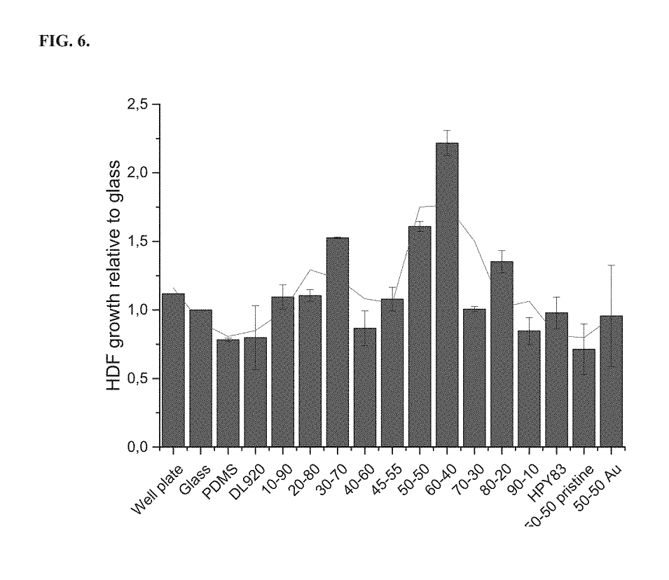

As seen in FIG. 6 a clear increase or decrease in cell growth is visible after 3 days of incubation in the latex coated coverslips when Human Dermal Fibroblast (HDF) are grown on the specifically tailored nanostructured surface. This increased or decreased cell growth could be utilized when controlling cell division is desired, such as in the case of food products, consumer products and medical devices.

Another food package platform type is based on non-transparent support such as paper, cardboard or similar natural fiber based material combined or supported with a structured and functionalized latex-film that can be mass produced at low cost. This version is suitable to be used as container for food products that easily perish such as fast food, ready-made meals, ice cream containers and milk or juice cartons. The life-span of the product could be further prolonged by functionalizing the latex coated container with an active molecule such as nanoparticles, silver ions or antibiotics. These compounds could be deposited (e.g. coated, printed etc.) directly on the paper or added to the medium of the food product.

By including a radio frequency identification (RFID) device on the substrate connected to the sensing electrode, it is possible to send and receive information regarding the content of the product (see e.g. FIG. 8). That would give real-time information regarding the current state of the product, for example if the food is spoiled or edible or if the cold chain was broken during storing and transport.

In the context of the present invention, the term “RFID sensor”, “RFID chip”, or “RFID device” can relate to a passive RFID tag or a passive RFID transponder and the like defining any RFID transponder which is powered by an electromagnetic wave, i.e. a remotely powered RFID transponder.

The term “RFID sensor”, “RFID chip”, or “RFID device” can also relate herein to an active RFID tag or an active RFID transponder and the like defining any RFID transponder which is powered by its own energy source and/or a local energy source, i.e. a self-powered RFID transponder.

In the context of the present invention, the term “reader” or “RFID reader” defines a device configured to communicate via electromagnetic waves with one or more RFID devices, for example such as one or more RFID transponders. A smartphone or computer may comprise such a reader.

The RFID chip comprises an antenna or an antenna is electrically coupled to the RFID chip and configured to receive signals from and transmit signals to a RFID reader. The RFID chip is also provided with an electrical interface to the sensing material, i.e. a nanostructured latex film functionalized with a sensing electrode. The RFID chip is preferably configured to modulate a signal received from a reader and to drive the sensing material with the modulated signal.

The present invention is also directed to a method for controlling and monitoring bacterial cell growth in a food packaging, the method comprising the steps of:
attaching or adding the nanostructured latex film functionalized with a sensing electrode and/or an anti-microbial coating into a food package or onto food packaging material;
optionally contacting said film with a food product; and
optionally reading data from a sensing electrode of said film using a built-in device, such as an RFID sensor, of said film transmitting information thru a reader or an electronic device such as smartphone or computer.

In the following Experimental Section, latex films according to the present technology were used as substrates for evaporated ultrathin and semi-transparent gold electrodes with nominal thicknesses of 10 nm and 20 nm. Optical properties and topography of the samples were characterized using UV-vis spectroscopy and Atomic Force Microscopy (AFM) measurements, respectively. Electrochemical impedance spectroscopy (EIS) measurements were carried out for a number of days to investigate the long-term stability of the electrodes. The effect of 1-octadecanethiol (ODT) and HS(CH₂)₁₁OH (MuOH) thiolation and protein (human serum albumin, HSA) adsorption on the impedance and capacitance was studied. A typical ˜10% decrease of capacitance at 100 Hz was observed [30] after immobilization of 1 mg/mL HSA on the bare and ODT functionalized gold electrodes in still conditions. The corresponding change of capacitance on the hydrophilic MuOH functionalized electrode was negligible. The performance of the electrodes was tested also under flow conditions with EIS measurements. In addition, cyclic voltammetry (CV) measurements were carried out to determine active medicinal components, i.e., caffeic acid with interesting biological activities and poorly water-soluble anti-inflammatory drug, piroxicam.

### Experimental Section

Materials and Methods

i. Template Substrates

Four different AFM calibration grids (models: TGG1, TGZ2, TGT1 and TGX1, NT-MDT, Russia), microscope glass slides (Menzel-Glaser, Thermo scientific, Germany), Polydimethylsiloxane (PDMS) (Wacker, Germany) and a multilayer curtain coated paper were used as model template substrates from which the latex coatings were peeled off.

ii. Coating Material

The two component coating latex blend with a weight ratio of 1:1 was prepared by mixing aqueous dispersions of polystyrene particles (HPY83; average particle size=140 nm, T_{g}=105° C., wt. %=48.0, DOW) and styrene butadiene acrylonitrile copolymer (HPC26; average particle size=140 nm, T_{g}=8-10° C., wt. %=49.5-50.5, DOW).

iii. Latex Film Fabrication

Different film fabrication methods were used to obtain a latex polymer film, for example rod coating was applied on paper substrates and glass substrates and drop-casting was used on calibration grids and glass cover slips. After the films appeared dry, they were sintered using an IR lamp (IRT systems, Hedson Technologies AB, Sweden) for 30-60 s in order to anneal the particles. The samples were immersed in water and washed in an ultrasound bath (FinnSonic m08) for 10 s and then the latex films were peeled off from the template substrates. The fidelity of the replication technique greatly depends on the properties of the template materials. For example, peeling of a thin latex film from a more porous precipitated calcium carbonate (PCC) coated paper substrate was not feasible. On the other hand, the low surface energy, durability, flexibility and low adhesive force [31] of polydimethylsiloxane (PDMS)—based templates make them ideal template materials. The latex film thickness also has an influence, i.e., thicker latex films are generally easier to peel off from the templates, but their drying time is long and transparency lower. Naturally the shape of the templates also somewhat influences the fidelity of the peeling process. For example 5 the latex film was easier to peel off from the TGZ2 grid (with vertical and horizontal surface features) compared to TGX1 grid with chessboard-like array of square pillars with sharp undercut edges. With a low coating amount the IR treatment reached throughout the whole coating thickness creating the characteristic nanopatterned structure within the higher hierarchical pattern. In case of thicker coating amounts, an additional IR treatment could be performed after the peeling process to obtain a typical heat-treated surface structure also on the bottom side.

iv. Fabrication and Functionalization of Ultrathin Gold Film Electrodes

The ultrathin gold films (UTGF) with nominal thicknesses of 10 nm and 20 nm were fabricated on the self-supported latex films using physical vapour deposition (PVD) with resistive heating. The film was attached on the shadow mask that was used for patterning. The gap between the evaporated gold electrodes was ˜190 μm and the width of the electrodes 5 mm. The dimensions of the contacts were 1 mm×12 mm. The evaporation was done under high vacuum 2-5×10⁻⁶ mbar during two separate runs using a heated aluminium-coated tungsten basket. The evaporation rate was set to 1 Å/s. A deposition monitor (XTM/2, Inficon) was used for gravimetric determination of the amount of evaporated gold on the film surface. The topographical characterization and electrochemical application of the UTGF electrodes on paper-supported latex coatings have been previously described elsewhere [27]. Briefly, a nominal thickness of 10 nm yielded UTGF electrodes with semiconducting (n-type) characteristics and polycrystalline grain structure with grain thickness of about 2 nm. Respectively, a nominal thickness of 20 nm yielded conductive UTGF electrodes (resistivity: 2.6×10-6 Ω cm) with grain thickness of about 6 nm. Similar characteristics were observed also for the UTGF electrodes on the self-supported latex film.

Functionalization of the UTGF electrodes with a self-assembled monolayers (SAMs) were carried out with a hydrophobic 1-octadecanethiol (ODT, Fluka Chemika) in ethanol and with a hydrophilic HS(CH₂)₁₁OH (MuOH, Sigma-Aldrich) in water. Before thiolation, the evaporated UTGF electrodes were cleaned with plasma (air) flow (PDC-326, Harrick) for 2 min and rinsed or immersed in absolute ethanol. The plasma treated self-supported latex films with UTGFs were placed on a microscope glass support and sealed with a silicone ring in a custom-built liquid flow cell (FIAlab Instruments, Inc., USA) (Appendix, A1) and exposed to the thiol solution (ODT: 500 μL, 5 mM/MuOH: 500 μL, 446 μM) for 24 h at room temperature under a cap. After the SAM formation, the ODT-functionalized electrodes were rinsed with absolute ethanol and 0.1 M KCl and the MuOH-functionalized electrodes with water and 0.1 M KCl solution. The HSA protein adsorption studies were conducted using 0.1 M KCl as the supporting electrolyte.

Characterization

Transmission UV-vis spectroscopy measurements were carried out using a Perkin-Elmer Lambda 900 with an integrating sphere setup.

Electrical Impedance spectroscopy (EIS) measurements were performed using a portable electrochemical interface and impedance analyzer (CompactStat, Ivium Technologies, The Netherlands). The experiments were carried out with a two electrode setup for keeping the electrode construction planar and simple. An aluminum foil was placed on top of the ultrathin gold electrode contacts before thin metal probes were pressed on the contacts connecting the gold electrodes to the CE and WE cables of the instrument. The electrolyte solution was applied on top of the electrodes using a liquid cell. A capacitance vs. potential plot for the gold electrodes with 10 nm and 20 nm nominal thicknesses was first measured in 0.1 M KCl to determine the point of zero charge (E ˜0 V). The impedance measurements throughout the work were recorded at a constant dc-potential (0 V) and with an applied sinusoidal excitation signal of 10 mV at a frequency range of 10000 Hz-10 Hz. In the flow measurements the solutions with a total volume of at least 5 mL were circulated with a flow rate of 23 μL/s using a peristaltic pump (101U/R Watson Marlow, England).

CV measurements were carried out using the same CompactStat and liquid cell setup. The electrode system consisted of an gold working electrode (WE), an gold counter electrode (CE) and a conventional Ag/AgCl (3M KCl) (Metrohm) reference electrode. The electrodes were not placed in the middle of the liquid cell but slightly off so that the area of the WE (˜7.3 mm2) was smaller than the area of the CE. A scan rate of 25 mV/s was used and the potential was cycled between −0.2 V and +0.8 V in case of caffeic acid (3-(3,4-dihydroxyphenyl)-2-propenoic acid) solution and between 0 V and +0.8 V in case of piroxicam (4-hydroxy-2-methyl-N-(2-pyridyl)-2H-1,2-benzothiazine-3-carboxamide-1,1-dioxide) solution. 0.1 M KCl in water was directly used as the supporting electrolyte.

An NTEGRA Prima (NT-MDT, Russia) atomic force microscope (AFM) was used for analyzing the surface topography of the peeled latex films. The images were scanned in air operating with intermittent-contact mode at the repulsive regime using rectangular cantilevers (NSG10 NT-MDT, Russia) with a 0.3 Hz scan rate at ambient conditions (T=27±2° C., Relative humidity, RH=44±3%). The images were processed and analyzed using the SPIP (Scanning Probe Image Processor, Image Metrology, Denmark) software. Contact angle measurements were carried out with a CAM200 contact angle goniometer (KSV Instruments Ltd.) at ambient conditions (T=29.8° C., RH=38.4%). Small 2 μL sized water (Millipore) droplets were placed on the samples and the contact angle values were recorded as a function of time.

Results and Discussion

a. Preparation and Topographical Characterization of Hierarchically Structured Self-Supported Films and Semi-Transparent Electronics

Different kinds of template substrates were used for the preparation of the self-supported latex films depending on the hierarchical structure desired. For example, sub-nanometer and nanometer scale features can be prepared by rod-coating the latex blend dispersion on a pigment coated paper substrate. After an IR treatment a distinct nanostructured topography with bimodal height distribution and random distribution, depending on the ratio of soft and hard components in the latex blend [32] was obtained. It is notable that the top-side structure of the self-supported film remained unchanged compared to the structure of the coating still being attached to the supporting substrate indicating that the peeling-off process did not cause any apparent changes or defects on the surface structure of the latex film (with a thickness of approximately 5.1 μm).

Higher hierarchical ordering can be achieved by applying the latex coating on substrates with lithographically pre-patterned structures. Here, we used AFM calibration grids due to their very precise sub-micron or micron periodic structure. After coating, IR sintering and agitation treatment, the latex film was peeled off. The periodic structures on both the latex film and the calibration grid appear as rainbow-like iridescent colors. The colors are created by structural coloration [33] and thus appear only on the effective 3 mm x 3 mm central square of the 5 mm×5 mm TGZ2 chip. Comparison of vertical and lateral dimensions of the surface features in the AFM line profiles to the dimensions of the AFM calibration grid gratings show that a negative replica of the calibration grid structure was very accurately produced.

b. Optical Characterization

Optical transparency of the self-supported latex films was determined by UV/vis spectrophotometer in transmission mode. About 80% optical transmission in the visible light region (400-700 nm) was achieved with the self-supported films that were peeled off from a paper substrate and wetted with water or soaked with linseed oil from the backside. About 10% less light was transmitted when the films were in dry state. This change was clearly seen also by naked eye. To create a typical bimodal surface on both sides of the peeled latex films, a glass slide was used as the template. Thereby also the optical transparency was enhanced to approximately 90%.

The optical transparency of the self-supported latex films decreased to around 45-50% after the deposition of UTGF electrodes. For comparison, the optical transparency of an ITO top electrode (processed at low temperature) used in solar cells has an average transmittance of above 85% [34].

The UTGFs had a typical polycrystalline grain morphology commonly observed for vapordeposited UTGFs [27]. The average grain height in the UTGFs with a nominal thickness of 10 nm and 20 nm was 2.5±0.5 and 6.2±0.3 nm, respectively. These correspond to the height values previously obtained for UTGFs on paper-supported latex coating [27]. The lack of a clear dip in transmission after ˜500 nm typically observed for discontinuous UTGFs due to localized surface plasmon resonance absorption [35] indicates that UTGFs on self-supporting latex film are quite continuous. UTGFs on paper-supported latex coatings have been shown to form a continuous, interconnected island network on the surface even with nominal thickness of 10 nm [27]. This seems to be true also here and explains the high conductivity of UTGF with nominal thickness of 20 nm [27]. The thicker UTGF showed a pronounced decrease in optical transmission at longer wavelengths whereas the transmission of the thinner UTGF remained quite stable. This trend follows that shown for ideal UTGFs (i.e. consisting of a single Au layer with homogeneous density) by theoretical calculations [32]. Theoretical transmission curves calculated by the transfer-matrix method using the bulk dielectric function of gold predict a faster drop of the optical transmission in VIS/NIR region as a function of film thickness. The resistance (R) of the UTGF evaporated on the latex film peeled off from the TGZ2 template surface was measured with a Fluke 73 III multimeter using two probes at a distance of 4 mm from each other. Almost equal R-values were measured when the probes were placed in parallel with the lines (9.7 W) and across the lines (11.4 W). This further demonstrates the good continuity of the evaporated gold films even on structured surfaces.

c. Electrochemical Characterization

Impedimetric measurements have been carried out with paper-based printed and evaporated gold electrodes previously [27, 36, 37, 28] in steady state. Here the EIS studies were carried out with the transparent self-supported nanostructured latex versions for extended time periods as a good long term stability of the UTGF electrodes is necessary e.g. in the field of cell growth, migration and proliferation where the time span of various processes can be several days. Good barrier properties are important for obtaining stable readings in liquid medium. One benefit related to the use of the self-supported latex films is that in case of a small pinhole or defect in the latex film (or substrate with inadequate barrier properties e.g. pristine latex coating) there is no supporting base paper substrate that would suck the liquid or solution which would cause e.g. unwanted concentration changes. The capacitance of the ODT-functionalized electrodes remained extremely constant at 133±2 nF for several hours after the initial stabilization. The obtained capacitance decrease from 202 nF was approximately 34%.

CV measurements were carried out with two pharmaceutically interesting model compounds, i.e., caffeic acid and piroxicam. 0.1 M KCl in water was directly used as the supporting electrolyte without any optimization to lower the oxidation potential of the compounds e.g. by changing the solution pH or the electrolyte and its concentration [38]. The profiles of the cyclic voltammograms measured with the highest caffeic acid concentration are quite characteristic for caffeic acid sample showing one anodic peak at 505 mV and one cathodic peak at 280 mV [38]. Piroxicam on the other hand is voltammetrically oxidizable and showed only the oxidation peak [39].

### REFERENCES

[1] K. B. Biji, C. N. Ravishankar, C. O. Mohan and T. K. Srinivasa Gopal, “Smart packaging systems for food applications,” Journal of Food Science and Technology, vol. 52, no. 10, pp. 6125-6135, 2015.

[2] M. Ghani, C. A. Cozzolino, G. Castelli and S. Farris, “An overview of the intelligent packaging technologies in the food sector,” Trends in Food Science & Technology, vol. 51, no. 1-11, pp. 0924-2244, 2016.

[3] E. Mohebi and L. Marquez, “Inteeligent packing in meat industry: An overview of existing solutions,” Journal of Food Science, vol. 52, no. 7, pp. 3947-64, 2015.

[4] S. Yilidirim, B. Röcker, M. K. Pettersen, J. Nilsen-Nygaard, Z. Ayhan, R. Rutkaite, T. Radusin, P. Suminska, B. Marcos and V. Coma, “Active Packagin Applications for Food,” Comprehensive Reviews in Food Science and Food Safety, vol. 17, no. 1, pp. 165-199, 2018.

[5] M. E. De Rosa, Y. Hong, R. A. Faris and H. Rao, “Microtextured polystyrene surfaces for three dimensional cell culture mad by a smiple solvent treatment method,” J. Appl. Polym. Sci., vol. 131, 2014.

[6] J. Lee, M. J. Cuddihy and N. A. Kotov, “Three-dimensional cell cultrue matrices: state of the art,” Tissue Engineering Part B: Reviews, no. 14, pp. 61-86, 2008.

[7] X. Le, G. E. J. Poinern, N. Ali, C. M. Berry and D. Fawcett, “Engineering a Biocompatible Scaffold with Either Micrometre or Nanometre Scale Surface Topography for Promoting Protein Adsorption and Cellular Response,” Int. J. Biomater., 2013.

[8] R. Flemming, C. Murphy, G. Abrams, S. Goodman and P. Nealey, “Effects of synthetic micro- and nao-structured surfaces on cell behavior,” Biomaterials, no. 20, pp. 573-588, 1999.

[9] Y. Li, G. Huang, X. Zhang, L. Wang, Y. Du, T. Lu and F. Xu, “Engineering Cell Alignment in vitro,” Biotechnol. Adv., no. 32, pp. 9177-9184, 2014.

[10] W. Pfleging, M. Bruns, A. Welle and S. Wilson, “Laser assisted modification of polystyrene surfaces for cell cultrue applications,” Appl. Surf Sci., no. 253, pp. 9177-9184, 2007.

[11] R. Oritz, S. Moreno-Florez, I. Quintana, M. Vivanco, J. R. Sarasua and J. Toca-Herrera, “Ultra-fast laser microprocessing of medical polymers for cell engineering applications,” Mater. Sci. Eng. C, pp. 241-250, 2014.

[12] J. Li, R. McNally and R. Shi, “ Enhanced neurite alignment on micropatterned poly-L-lactic acid films,” j. Biomed. Mater. Res. A, pp. 392-404, 2008.

[13] J. G. Fernandez, C. A. Mills, E. Martinez, M. J. Lopez-Bosque, X. Sisquella, A. Errachid and J. Samitier, “Micro- and naostructuring of freestanding biodegradable, thin sheets chitosan via soft lithography,” J. Biomed. Mater. Res. A, pp. 242-247, 2008.

[14] J. Zhang, J.-Y. Ou, N. Papasimakis, Y. Chen, K. MacDonald and N. I. Zheludev, “Continuous metal plasmonic frequency selective surfaces,” Opt. Express, vol. 19, pp. 23279-23285, 2011.

[15] M. D. Morariu, N. E. Voicu, E. Schäffer, Z. Lin, T. P. Russell and U. Steiner, “Hierarchical structure formation and pattern replication induced by an electric field,” Nature Materials, no. 2, pp. 48-52, 2003.

[16] L. Costa de Medeiros Dantas, J. Paulo da Silva-Neto, T. S. Dantas, L. Z. Naves, F. D. das Neves and A. S. da Mota, “Bacterial Adhesion and Surface Roughness for Different Clinical Techniques for Acrylic Polymethyl Methacrylate,” International Journal of Dentistry, 2016.

[17] V. K. Truong, R. Lapovok, Y. S. Estrin, S. Rundell, J. Y. Wang, C. J. Fluke, R. J. Crawford and E. P. Ivanova, “The influence of nano-scale surface roughness on bacterial adhesion to ultrafine-grained titanium,” Biomaterials, vol. 31, no. 13, pp. 3674-3683, 2010.

[18] S. Bagherifard, D. J. Hickey, A. C. de Luca, V. N. Malheiro, A. E. Markaki, M. Guagliano and T. J. Webster, “The influence of nanostructured features on bacterial adhesion and bone cell functions on severely shot peened 316L stainless steel,” Biomaterials, vol. 73, pp. 185-197, 2018.

[19] C. Serrano, L. Garcia-Fernandez, J. P. Fernández-Blázquez, M. Barbeck, S. Ghanaati, R. Unger, J. Kirkpatrick, E. Arzt, L. Funk, P. Turón and A. del Campo, “Nanostructured medical sutures with antibacterial properties,” Biomaterials, vol. 52, pp. 291-300, 2015.

[20] H. Juvonen, A. Määttanen, P. Laurén, P. Ihalainen, A. Urtti, M. Yliperttula and J. Peltonen, “Biocompatibility of printed paper-based arrays for 2-D cell cultures,” Acta Biomaterialia, vol. 9, pp. 6704-6710, 2013.

[21] A. Määttänen, A. Fallarero, J. Kujala, P. Ihalainen, P. Vuorela and J. Peltonen, “Printed paper-based arrays as substrates for biofilm formation,” AmB Express, no. 4, pp. 1-12, 2014.

[22] P. Kumar, H. Reinitz, J. Simunovic, K. Sandeep and P. Franzon, “Overview of RFID technology and its applications in the Food Industry,” JFSR: Concise REviews and Hypotheses in Food Science, vol. 74, no. 8, 2009.

[23] R. A. Potyrailo, N. Nagraj, Z. Tang, F. J. Mondello, C. Surman and W. Morris, “Battery-free radio frequency identification (RFID) sensors for food quality and safety,” J Agric Food Chem, vol. 35, no. 60, pp. 8535-8543, 2012.

[24] J. Koskela, J. Sarfraz, P. Ihalainen, A. Määttänen, P. Pulkkinen, H. Tenhu, T. Nieminen, A. Kilpela and J. Peltonen, “Monitoring the quality of raw poultry by detecting hydrogen sulphide with printed sensors,” Sensors and Actuators B: Chemical, 218 89-96, 20, no. 218, pp. 89-96, 2015.

[25] S. Janssen, K. Schmitt, K. M. Blanke, M. L. Bauersfeld, J. Wöllenstein and L. W., “Ethylene detection in fruit supply chains,” Philos Trans A Math Phys Eng Sci, no. 372, 2014.

[26] P. Kuberský, T. Syrový, A. Hamác̆ek, S. Nes̆půrek and J. Stejskal, “Printed flexible gas sensors based on organic materials,” Procedia Eng., no. 120, pp. 614-617, 2015.

[27] P. Ihalainen, A. Määttänen, M. S. P. Pesonen, J. Sarfraz, R. Österbacka and j. Peltonen, “Paper-supported nanostructured ultrathin gold film electrodes—Characterization and functionalization,” Appl. Surf Sci, no. 329, pp. 321-329, 2015.

[28] P. Ihalainen, H. Majumdar, T. Viitala, B. Törngren, T. Närjeoja, A. Määttänen, J. Sarfraz, H. Härmä, M. Yliperttula, R. Österbacka and J. Peltonen, “Application of Paper-Supported Gold Electrodes for IMpedimetric Immunosensor Development,” Biosensors, no. 3, pp. 1-17, 2012.

[29] F. Asphahani, M. Thein, O. Veiseh, D. Edmondson, R. Kosai, M. Veiseh, J. Xu and M. Zhang, “Influence of cell adhesion and spreading on impedance characteristics of cell-based sensors,” Biosens Bioelectron, vol. 8, no. 23, pp. 1307-13, 2007.

[30] L. Jiang, J. Liu, J. Shi, X. Li, H. Li, J. Liu, J. Ye and Y. Chen, “Impedance monitoring of cell adhesion and growth on mesoporous membrane,” Microelectronic Engineering, vol. 8, no. 88, pp. 1722-1725.

[31] M. Jin, X. Feng, j. Xi, J. Zhai, K. Cho, L. Feng and L. Jiang, “Super-hydrophobic PDMS surface with ultra-low adhesive force,” Macromol. Rapid Commun., no. 26, pp. 1805-1809, 2005.

[32] R. Reach Toim, Characterisation of Areal Surface Texture, Berlin: Heidelberg Springer: Berlin, 2013.

[33] J. Sun, B. Bhushan and J. Tong, “Structural Coloration in nature,” RSC Advances, vol. 3, pp. 14862-14889, 2013.

[34] X. Wang, G.-M. Ng, J.-W. Ho, H.-L. Tam and F. Zhu, “Efficient Semitransparent Bulk-Heterojunction Organic Photovoltaic Cells with High-Performance Low Processing Temperature Indium Tin Oxide Top Electrode,” IEEE J. Sel. Top. Quantum. Electron., no. 16, pp. 1685-1689, 2010.

[35] S. Norrman, T. Andersson, C. G. Granqvist and O. Hunderi, “Optical properties of discontinuous gold films,” Phys. Rev. B, vol. 18, pp. 674-695, 1978.

[36] P. Ihalainen, F. Petterson, M. Pesonen, T. Viitala, A. Määttänen, R. Österbacka and J. Peltonen, “An impedimetric study of DNA hybridization on paper-supported inkjet-printed gold electrodes,” Nanotechnology, no. 25, 2014.

[37] P. Ihalainen, H. Majumdar, A. Määttänen, S. Wang, R. Österbacka and J. Peltonen, “Versatile characterization of thiol-functionalized printed metal electrodes on flexible substrates for cheap diagnostic applications,” Biochim. Biophys. Acta BBA, no. 1830, pp. 4391-4397, 2013.

[38] C. Giacomelli, K. Ckless, D. Galato and F. S. S. A. Miranda, “Electrochemistry of Caffeic Acid Aqueous Solutions with pH 2.0 to 8.5,” J. Braz. Chem. Soc., no. 13, pp. 332-338, 2002.

[39] K. Asadpour-Zeynali, M. R. Majidi and M. Zarifi, “Carbon ceramic electrode incorporated with zeolite ZSM-5 for determination of Piroxicam,” Cent. Eur. K Chem., no. 8, pp. 155-162, 2010.

1. A nanostructured latex film functionalized with a sensing electrode for controlling and monitoring bacterial cell growth in food packaging, said film comprising a device for sending and receiving data and information.

2. The film according to claim 1, wherein said film is functionalized with coated, printed or evaporated sensing electrodes, preferably semi-transparent electrodes.

3. The film according to claim 1, wherein said device is a radio-frequency identification (RFID) sensor.

4. The film according to claim 1, wherein said film comprises a blend of two latexes.

5. The film according to claim 4, wherein said two latexes are polystyrene and styrene butadiene acrylonitrile copolymer.

6. The film according to claim 1, wherein said sensing electrode is an ultrathin metal film electrode (UTMF) or a conductive semitransparent or transparent polymer such as PEDOT:PSS.

7. The film according to claim 1 further functionalized with antibiotics, metal ions, nanoparticles, printed biomolecule films or self-assembled thiol monolayers.

8. The film according to claim 1, wherein said film is placed upon a support, attached to a support or said film is a coat applied to a support so as to form a composite.

9. The film according to claim 8, wherein said support is composed of transparent or semi-transparent material such as glass or plastic.

10. The film according to claim 8, wherein said support is composed of non-transparent material such as paper or cardboard.

11. The film according to claim 8, wherein said support is food packaging material.

12. A food packaging comprising a nanostructured latex film.

13. The food packaging according to claim 12, wherein said film is functionalized with a sensing electrode for controlling and monitoring bacterial cell growth, said film comprising a device for sending and receiving data and information.

14. The food packaging according to claim 13, wherein said sensing electrode provides data and information on one or several of the following features: glucose content, pH, sulfur compounds, biogenic amines, cell adhesion, cell growth and cell morphology.

15. Method for controlling and monitoring bacterial cell growth in a food packaging, the method comprising the step of:
attaching or adding a nanostructured latex film into a food package or onto food packaging material.

16. The method according to claim 15, wherein said film is functionalized with a sensing electrode and/or an anti-microbial coating.

17. The method according to claim 15 comprising the further steps of:
contacting said film with a food product, and
optionally reading data from a sensing electrode of said film using a built-in device of said film transmitting information thru an electronic device such as smartphone or computer.

18. The method according to claim 17, wherein said built-in device is an RFID sensor.

19. The method according to claim 16, wherein said sensing electrode provides data and information on one or several of the following features: glucose content, pH, sulfur compounds, biogenic amines, cell adhesion, cell growth and cell morphology.
